(19) United States
(12) Patent Application Publication
(10) Pub. No.: US 2009/0262332 A1
(43) Pub. Date: Oct. 22, 2009

(54) HIGH-THROUGHPUT SPECTRAL IMAGING AND SPECTROSCOPY APPARATUS AND METHODS

(75) Inventors: Jeff Qiang Xu, Sugar Land, TX (US); Jiang Ping Yi, Huzhou (CN); Xiao Ping Zhou, Changsha (CN)

Correspondence Address: BAKER & MCKENZIE LLP, Pennzoil Place, South Tower, 711 Louisiana, Suite 3400, HOUSTON, TX, 77002-2716, US

(73) Assignee: MICROVAST, INC., Stafford, TX (US)

(21) Appl. No.: 12/105,676

(22) Filed: Apr. 18, 2008

(51) Int. Cl. G01J 3/12

(52) U.S. Cl. 356/51; 356/331

(57) ABSTRACT

Disclosed are high-throughput spectral imaging and spectroscopy apparatus and methods that acquire the property information of measured substance's UV-visible and infrared radiation through using at least one substantially uniform monochromatic incident irradiation source and spatial resolved array detector. The high-throughput analysis is achieved by acquiring a parallel spectral imaging and spectroscopy over a library element substrate. The apparatus and methods include both hardware and software for achieving both spectral imaging and spectroscopic analysis.

### FEDERALLY SPONSORED RESEARCH

Not applicable

### REFERENCE TO MICROFICHE APPENDIX

Not applicable.

### FIELD OF THE INVENTION

The present invention generally relates to apparatus and methods for high-throughput screening or acquiring property information of measured substances that have been created or produced at known locations on a library element substrate. More specifically, the invention is to utilize the specific diffuse reflectance spectral property over solid media for any substances at a fixed wavelength or frequency.

### BACKGROUND OF THE INVENTION

Substances can absorb, reflect, diffract, refract, scatter, and transmit incident irradiation light, and moreover can be illuminated to emit fluorescent and phosphorescent lights through different excitation mechanisms. These phenomena are tightly related with the chemical structures, chemical compositions, surfaces, and formats of under measured substances and are also related to the types of incident irradiation light sources used for example at different wavelengths or different power size. As known, radiation refers to electromagnetic wave energy with a wavelength between 10⁻⁴ and 10⁴ m, which covers the radiation from gamma radiation, x-ray light, ultraviolet light, visible light, infrared light, microwave, and radio waves. Diffuse Reflectance Spectroscopy (DRS) is a technique that collects and analyzes scattered light energy over a solid media surface. Since the scattering is considerable for solids when the incident light wavelength is in the order of magnitude of the solid particle sizes, this technique is widely used for measurement of fine particles, powders, and rough surface.

Recently, the discovery of new materials with novel properties and applications is accelerated because of the progress of high-throughput screening and analytical technologies. Although there is still a need to find a more efficient, economical, and systematic way for synthesizing and screening novel materials having desired physical and chemical properties, the high-throughput methodology has partially solved the challenge of being able to synthesize and screen new compounds simultaneously. As seen, the pharmaceutical industry has applied this technique to its process to generate and screen large libraries for new drug discovery and drug formulation.

Both synthesis and detection technologies are very important for libraries screening processes in the pharmaceutical industry for drug discovery and formulation, in the chemical industry for catalyst discovery and process development, and in the material industry for novel compound discovery and detection of its properties, and so on.

A major challenge with these processes is the lack of reliable and fast testing methodology for rapid screening and optimization. To accomplish this goal, first of all, an apparatus set-up in a parallel-detection mode is better than an apparatus set-up in a serial-detection mode. Due to the nature of high-throughput library array screening and the nature of many chemical reactions, a simultaneous and equal chemical environment is very important for all measured substances or reaction products on the substrate for a fair comparison. By using the parallel-detection mode, thousands of substances or products can be screened in a very short timeframe. Thus, the parallel-detection is obviously superior to the serial-detection mode.

Secondly, the library screening should be operated by measuring the unique properties of novel substances or their representative compounds, and additional label substances would not affect the measurement result if they are added in the screening process.

Thirdly, the detection protocol or methods must be accurate and sensitive because the library screening process is often associated with small amount of substances or products to be detected.

Fourthly, an apparatus with less moving parts in the system is preferred.

Fifthly, an apparatus that is flexible and has the potential of switching to a different measurement set-up by changing either an incident irradiation source or a detector or both.

Finally, an apparatus must be cost-effective and applicable to other existing high-throughput instrumentation platforms.

The real benefits for a high-throughput screening technique are quick synthesis and measurement of a large number of substances simultaneously. The critical point is whether the technique equips the ability to measure substances and to process a large amount of data simultaneously. Normally, the characterization and quantitative analysis of measured substances are the bottlenecks of many high-throughput screening techniques. A partial solution to solve above-mentioned challenges is to utilize known properties of various light sources to the measured substances, to leverage technology progresses in providing light sources, signal detectors, and software, and to look into the spectral imaging and spectroscopy of each substance, meantime, to address the uniqueness of library screening process. Obviously, there is a great need to find the apparatus and methods to solve the bottlenecks. This invention has partially provided the solutions for the above-mentioned challenges.

Lee et al. have reported an evaluation of a near-infrared chemical imaging (NIR-CI) system through measuring the content uniformity of multiple drug tablets simultaneously (Spectroscopy, 21(11), November 2006). One system offered by Spectral Dimensions, Inc., Olney, Mayland under the mark MatrixNIR™ uses a focal plane array detector that can collect tens of thousands of spatially distinct NIR spectra simultaneously. This instrument uses a computer controlled sample near-infrared illumination system and has a spectral range between 950 and 1750 nm. The wavelength filter is placed before the detector. U.S. Pat. No. 6,483,112, entitled “High-throughput Infrared Spectroscopy” claims that the spectrometer comprises an infrared source, which is a common infrared illumination system but not a monochromatic irradiation source. The sensitivity of this instrument is ordinarily due to the limitation of its illumination system.

A calorimetric diffuse reflectance imaging (“CDRI”) high-throughput analysis system was developed by Yi et al. (J. Comb. Chem., 2006, 8, 881-889). The working principle of this system was that light from the sources irradiates over the array wells that contain sample solutions and quartz sands on the testing plate. The incident light diffuses in the solution and quartz sands and is reflected on the surface of quartz sands, and then goes through an optical filter to be detected by a charge-coupled device (“CCD”) camera. Two 8 Watt white mercury fluorescent lights were used as the light sources. Similarly, this system is using a non-monochromatic irradiation source, and the detection limit is ordinary as usual. The full characteristic diffuse reflectance spectrum is difficult to obtain because of optical filter's limitation.

U.S. Pat. No. 6,034,775 entitled “Optical Systems and Methods for Rapid Screening of Libraries of Different Materials” illustrates an embodiment to characterize the relative radiance, luminance, and chromaticity of an array of materials. The system uses an irradiation source as an excitation source but not a monochromatic incident irradiation source. Chromaticity filters are used before the luminance reaches the CCD detector. The sensitivity for this system was not described in the patent, but it is likely in the same range as that of the systems described in the foregoing references.

Commercially available ultraviolet and visible light (Uv-Vis) high-throughput spectroscometers are currently supplied by Molecular Devices Corp. (www.moleculardevices.com). Most of these instruments are automated and operate in a serial-analysis mode. One of the instruments, the SpectraMax M5/M5^{e} is a dual-monochromator, multi-detection microplate reader with a triple-mode cuvette port and 6-384 microplate reading capability. The detection modalities include UV-Vis absorbance, fluorescence intensity, fluorescence polarization, time-resolved fluorescence, and luminescence. The instrument measures samples one-by-one and includes moving parts. Since it is a serial-mode detection system, it has obvious disadvantages compared with parallel-mode detection for high throughput analysis.

The current invention uses at least one substantially uniform monochromatic irradiation source comprising a plurality of irradiation sources providing substantially uniform illumination of the library element substrate, and a wavelength filtering element is not present in the path of the radiation in the region between the library element substrate and the spatially resolved detector. These measures have demonstrated a lot of merits compared with the relevant prior arts mentioned above.

### SUMMARY OF THE INVENTION

According to one aspect of the current invention, the high-throughput spectral imaging and spectroscopy apparatus in this current invention comprises: at least one substantially uniform monochromatic incident irradiation source; a library element substrate including a plurality of wells defining a plurality of cavities; one or more optical components arranged to direct the irradiation source onto the library element substrate; a translational stage operably engaged with the library element substrate; and a spatially resolved detector responsive to the irradiation source.

According to another aspect of the current invention, a wavelength filtering element is not present in the path of the radiation in the region between the library element and the spatially resolved detector.

According to another aspect of the current invention, the irradiation source comprises a plurality of irradiation sources providing substantially uniform illumination of the library element substrate.

According to another aspect of the current invention, the apparatus includes an imaging box that houses the incident irradiation source, a data acquisition system, and a data reduction system.

According to another aspect of the current invention, the monochromatic radiation provided by the monochromatic irradiation source is selected from the group consisting of UV, UV-visible, and infrared radiation, and the irradiation source provides radiation having a wavelength between about 200 nm and about 800 nm and between about 800 nm and about 40,000 nm.

According to another aspect of the current invention, the monochromatic incident irradiation source includes one or more lamps, one or more monochromators, one or more lenses, and one or more mirrors.

According to another aspect of the current invention, the monochromatic incident irradiation source is remotely positioned with respect to the imaging box, and the components arranged to direct the irradiation source onto the library element substrate comprise fiber-optic cables and fiber-optic collimators.

According to another aspect of the current invention, the monochromatic incident irradiation source includes one or more lamps, one or more monochromators, two or more fiber-optic cables, and two or more fiber-optic collimators.

According to another aspect of the current invention, the library element substrate is a diffuse reflectance library element wherein one or more of the plurality of wells includes a substance that diffusely reflects the irradiation source, and the substance is a solid-phase substance selected from the group consisting of powders and fine particles.

According to another aspect of the current invention, the substance is mixture of liquid-phase substances and diffusely reflecting solid media particles, and the diffusely reflecting solid media particles do not substantially absorb the radiation from the irradiation source. The diffusely reflecting solid media particles are selected from silica and SPECTRALON® materials.

According to another aspect of the current invention, the plurality of wells is arranged on the library element in a circular, triangular, rectangular or square-shaped pattern, and the plurality of wells is suitable for performing a desired chemical reaction therein. The chemical reaction is a wet chemical reaction or a dry chemical reaction.

According to another aspect of the current invention, the high-throughput spectroscopy apparatus includes means for transferring reagents to one or more of the plurality of wells in the library element, and the means for transferring reagents comprises a mechanical system or a conduit system.

According to another aspect of the current invention, the library element substrate has no array wells.

According to another aspect of the current invention, the translational stage in the apparatus is moveable along at least one of an x-axis, a y-axis, a z-axis or an angle θ relative to the vertical axis of the apparatus, and further includes a computer-operated controller for moving the translational stage to a desired position.

According to another aspect of the current invention, the spatial resolved detector in the apparatus is selected from the group of UV-visible light detectors and infrared light sensitive CCD camera, infrared light sensitive photodiode array detector, and combinations thereof.

According to another aspect of the current invention, a method of conducting high-throughput spectral imaging and spectroscopy comprises: providing a source of substantially uniform monochromatic radiation; providing a library element substrate including a plurality of wells defining a plurality of cavities, the cavities having one or more substances therein, the substances including therein one or more diffusely reflecting solid media particles, wherein the diffusely reflecting solid media particles do not substantially absorb radiation provided by the sources; moving the library element substrate to the translational stage; directing the radiation onto the library element substrate; and detecting one or more signals associated with a reflected portion of the radiation via a spatially resolved detector.

According to another aspect of the current invention, the method does not include filtering the reflected portion of the radiation at one or more points between the library element substrate and the spatially resolved detector.

According to another aspect of the current invention, the measured substances in the method are in the liquid or solid-phase, and the solid-phase substances are metal or nonmetal oxides, metal or nonmetal halides, metal or nonmetal oxyhalides, or mixtures thereof.

According to another aspect of the current invention, the method further includes mixing diffusely reflecting solid media particles with the liquid phase or solid phase substances.

According to another aspect of the current invention, the method further includes transferring the substance to the plurality of wells with a manual process or an automated pipetting system or a plurality of conduits.

According to another aspect of the current invention, the method has following features: the spatially resolved detector is a CCD camera or photodiode array mounted on the top of an imaging box and captures a portion of the radiation reflected from the library element substrate; and the data acquired by the detector is processed by a data processing program configured to report information including reflectance, wavelength, or wavenumber, or calibration curve in a graphical format.

### BRIEF DESCRIPTION OF THE DRAWINGS

FIG. 1 illustrates an embodiment of the current invention for apparatus used to conduct the diffuse reflectance spectral imaging and spectroscopy.

FIG. 2 illustrates another embodiment of the current invention for apparatus used to conduct the diffuse reflectance spectral imaging and spectroscopy.

FIG. 3 illustrates another embodiment of the current invention for apparatus used to conduct the diffuse reflectance spectral imaging and spectroscopy.

FIG. 4a illustrates another embodiment of the current invention for apparatus used to conduct the diffuse reflectance spectral imaging and spectroscopy.

FIG. 4b is an overlook view of the fiber-optic collimator chassis.

FIG. 5 illustrates another embodiment of the current invention for apparatus used to conduct the diffuse reflectance spectral imaging and spectroscopy.

FIG. 6 illustrates an embodiment of the current invention for the library element substrate.

FIG. 7 is a cartoon picture illustration of diffuse reflectance of solid particles.

FIG. 8a is a typical diffuse reflectance spectral imaging of measured substances.

FIG. 8b is a typical full diffuse reflectance spectrum of measured substance.

FIG. 9 is a full visible characteristic diffuse reflectance spectrum for V₂O₅/MgF₂ photo-catalyst in different V₂O₅ concentration.

FIG. 10a is a full visible characteristic diffuse reflectance spectrum for KMnO₄.

FIG. 10b is a full visible diffuse reflectance spectrum of silica.

FIG. 11a is the calibration curve of the intensity of radiation reflected from the measured substances as the function of KMnO₄ concentration.

FIG. 11b is the calibration curve of the absorbance of measured substances as the function of KMnO₄ concentration.

FIG. 11c is the calibration curve of the intensity ratio of radiation reflected from the measured substances as the function of KMnO₄ concentration.

FIG. 11d is the calibration curve of Kubelka-Munk unit versus KMnO₄ concentrations.

FIG. 12 is an expanded calibration curve between Kubelka-Munk unit versus KMnO₄ concentration.

### DETAILED DESCRIPTION OF EMBODIMENTS OF THE INVENTION

The following description illustrates embodiments of the current invention by way of example and not by way of limitation. Thus, the embodiments described below represent preferred embodiments of the current invention.

The following terms are intended to have the following general meanings as used herein:

Monochromatic Incident Irradiation Source: A monochromatic incident irradiation source is a monochromatic light generated by either monochromators or monochromatic lamps as the incident irradiation source for irradiating measured substances on the library element substrate. In one embodiment of this current invention, the source may include lamps, monochromators, lenses, mirrors, fiber-optic cables, fiber-optic collimators, and the like.

Monochromator: Monochromator is an optical device that transmits a mechanically selectable narrow band of wavelengths of light or irradiation from light or lamp sources.

Incident Irradiation Source: The incident irradiation source in the current invention means that the light of electromagnetic wavelength is between 200 nm and 40,000 nm or wavenumber between 50,000 and 250 cm⁻¹, which covers a spectrum between UV-visible light and mid-infrared range light radiation.

Library Element Substrate: Library element substrate is a carrier that facilitates measured substances such as powders, particles, chips, sheets, tablets, and so on for a M rows and N columns array wells, wherein M and N are integers.

Array Wells: Array wells are an array in M rows and N columns on the library element substrate to facilitate the diffuse reflectance for measured substances. The array wells are in the shape of either circle, or triangle, or square, or any other geometric shapes in M rows and N columns, wherein M and N are integers.

Measured Substance: Measured substance is an under tested sample or chemical that is transferred or chemically reacted at a known or defined location on the library element substrate.

According to one aspect of the current invention, the high-throughput spectroscopy apparatus in this current invention comprises:
a. at least one substantially uniform monochromatic incident irradiation source;
b. a library element substrate including a plurality of wells defining a plurality of cavities;
c. one or more optical components arranged to direct the irradiation source onto the library element substrate;
d. a translational stage operably engaged with the library element substrate; and
e. a spatially resolved detector responsive to the irradiation source.

According to another aspect of the current invention, the substantially uniform monochromatic incident irradiation source is obtained by combining lamp, monochromator, and mirror. The substantial uniformity of irradiation source is confirmed through the following detailed experimental set-up and explanation:

a. type 7ILT75/250 tungsten lamp (wavelength range: 300-2500 nm, Beijing 7-star Instruments Co., Ltd.) is used and the lamp current is 11.10 A;

b. type 7ISW30 monochromator (focal length: 300 mm, dispersion: 2.7 nm/mm, grating: 1200 g/mm, Beijing 7-star Instruments Co., Ltd.) is used, and the entrance slit and exit slit are 1 mm and 3 mm in width respectively. The monochromatic wavelength is 580 nm;

c. a 100 mm×100 mm optical mirror is placed to generate uniform monochromatic incident irradiation source;

d. a 80 mm×80 mm facular in square is formed;

e. an irradiator is located and removed on square facular to obtain 16 readings at 16 spots in Table I (Irradiator: FGH-1 type photon meter, Beijing Normal University Optical-electrical Instrument Factory), and the reading unit is in μW/cm²; and

f. since precision can provide a measure of the random, or indeterminate, error of an analysis. The relative standard deviation (RSD) for above 16 readings or measurements is calculated to be 2.61%. Thus, the RSD demonstrates the extent of substantial uniformity of monochromatic incident irradiation source in this experimental set-up.

TABLE I

| | | | |
|---|---|---|---|
| 0.018 | 0.019 | 0.018 | 0.019 |
| 0.018 | 0.018 | 0.019 | 0.018 |
| 0.018 | 0.018 | 0.018 | 0.019 |
| 0.018 | 0.019 | 0.018 | 0.018 |

According to another aspect of the current invention, the substantially uniform monochromatic incident irradiation source is obtained by combining lamp, monochromator, lens, and mirror. The substantial uniformity of irradiation source is confirmed through the following detailed experimental set-up and explanation:

a. type 71LT75/250 tungsten lamp (wavelength range: 300-2500 nm, Beijing 7-star Instruments Co., Ltd.) is used and the lamp current is 11.10 A;

b. type 7ISW30 monochromator (focal length: 300 mm, dispersion: 2.7 mm/mm, grating: 1200 g/mm, Beijing 7-star Instruments Co., Ltd.) is used, and the entrance slit and exit slit are 1 mm and 3 mm in width respectively. The monochromatic wavelength is 580 nm;

c. a 75 mm in diameter optical lens (convex lens: focal length is 150 mm) is placed between the exit slit of monochromator and mirror;

d. a 100 mm×100 mm optical mirror is placed to generate uniform monochromatic incident irradiation source;

e. a 30 mm×50 mm facular in rectangular is formed;

f. an irradiator is located and removed on rectangular facular to obtain 16 readings at 16 spots in Table II (Irradiator: FGH-1 type photon meter, Beijing Normal University Optical-electrical Instrument Factory), and the reading unit is in μW/cm²; and

g. since precision can provide a measure of the random, or indeterminate, error of an analysis. The relative standard deviation (RSD) for above 16 readings or measurements is calculated to be 0.87%. Thus, the RSD demonstrates the extent of substantial uniformity of monochromatic incident irradiation source in this experimental set-up.

TABLE II

| | | | |
|---|---|---|---|
| 0.051 | 0.051 | 0.052 | 0.051 |
| 0.051 | 0.051 | 0.051 | 0.052 |
| 0.052 | 0.051 | 0.051 | 0.051 |
| 0.051 | 0.052 | 0.051 | 0.051 |

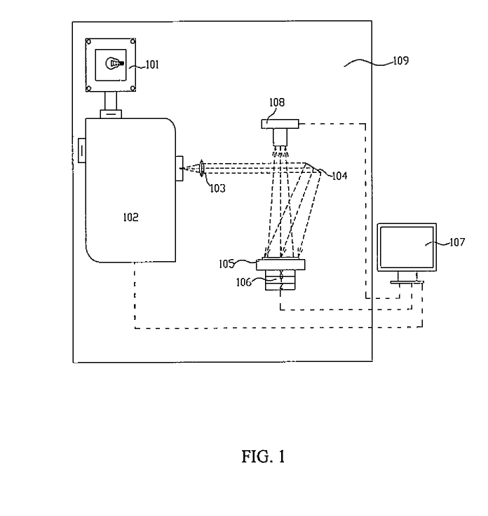

According to another aspect of the current invention, the substantially uniform monochromatic incident irradiation source in the high-throughput diffuse reflectance spectral imaging and spectroscopy apparatus has at least one irradiation source that generates substantially uniform light source over the library element substrate. In one embodiment illustrated in FIG. 1, a lamp 101, a monochromator 102, a lens 103, and a mirror 104 are used to produce the uniform light source over the library element substrate 105, where the substances are detected and measured. The library element substrate is fixed or placed on the top of a translational stage 106, which is controlled by a computer 107. The stage enables a fast, area-focused analysis if the library element substrate area is too large. The diffuse reflectance spectral imaging and spectroscopy are obtained by the spatial resolved detector such as a CCD camera 108, which is also controlled by the computer 107. The imaging and data can be acquired, processed, and reduced by the computer 107 as well. All 101, 102, 103, 104, 105, 106, and 108 are placed in the enclosure of an imaging box 109. According to another aspect of the current invention, the substantially uniform monochromatic incident irradiation source in the apparatus is generated from optical components including lamp, monochromator, and mirror, which are aligned accordingly as illustrated in FIG. 1 but without lens present. The uniformity of light source in this set-up is measured over a 10 cm×10 cm library substrate element that has 8×8 array wells located onto. The diffusely reflecting solid media particle is silica in this experiment. Table III is the reflectance intensity measured from each well. The average is calculated to be 929,638 and the Table IV gives a relative error for each well. The largest relative error for this experimental set-up is 2.48%.

TABLE III

| | | | | | | | |
|---|---|---|---|---|---|---|---|
| 917605 | 918246 | 921147 | 926844 | 930223 | 935382 | 946876 | 952656 |
| 921151 | 921041 | 923384 | 926828 | 932846 | 936115 | 945531 | 946347 |
| 924563 | 924938 | 929457 | 930225 | 933739 | 932658 | 938476 | 941904 |
| 928003 | 929690 | 933403 | 932776 | 930181 | 927977 | 932528 | 941046 |
| 925510 | 929505 | 932272 | 928833 | 925443 | 923964 | 931143 | 937836 |
| 925212 | 926962 | 929657 | 924771 | 922808 | 926943 | 930356 | 935818 |
| 924209 | 924086 | 928298 | 926338 | 925286 | 929973 | 931412 | 934052 |
| 918002 | 920908 | 922160 | 926245 | 924715 | 929346 | 930164 | 930807 |

TABLE IV

| | | | | | | | |
|---|---|---|---|---|---|---|---|
| −1.29% | −1.23% | −0.91% | −0.30% | 0.06% | 0.62% | 1.85% | 2.48% |
| −0.91% | −0.92% | −0.67% | −0.30% | 0.35% | 0.70% | 1.71% | 1.80% |
| −0.55% | −0.51% | −0.02% | 0.06% | 0.44% | 0.32% | 0.95% | 1.32% |
| −0.18% | 0.01% | 0.41% | 0.34% | 0.06% | −0.18% | 0.31% | 1.23% |
| −0.44% | −0.01% | 0.28% | −0.09% | −0.45% | −0.61% | 0.16% | 0.88% |
| −0.48% | −0.29% | 0.00% | −0.52% | −0.73% | −0.29% | 0.08% | 0.66% |
| −0.58% | −0.60% | −0.14% | −0.35% | −0.47% | 0.04% | 0.19% | 0.47% |
| −1.25% | −0.94% | −0.80% | −0.36% | −0.53% | −0.03% | 0.06% | 0.13% |

In another embodiment illustrated in FIG. 1, the substantially uniform monochromatic incident irradiation source in the apparatus is generated from optical components including lamp, monochromator, lens, and mirror, which are aligned accordingly as illustrated in FIG. 1. The uniformity of light source in this set-up is also measured as above-described. Table V is the reflectance intensity measured from each well. The average is calculated to be 1,168,569 and the Table VI gives a relative error for each well. The largest relative error for this experimental set-up is 3.91%.

TABLE V

| | | | | | | | |
|---|---|---|---|---|---|---|---|
| 1143410 | 1147771 | 1157630 | 1164358 | 1168006 | 1180477 | 1200751 | 1214211 |
| 1148453 | 1150851 | 1158809 | 1165732 | 1169665 | 1181006 | 1198330 | 1209836 |
| 1152092 | 1152578 | 1161206 | 1169327 | 1171894 | 1178003 | 1194751 | 1206081 |
| 1154817 | 1155548 | 1162904 | 1169716 | 1168728 | 1173469 | 1192553 | 1204578 |
| 1153152 | 1156022 | 1162765 | 1167871 | 1163179 | 1170506 | 1187782 | 1201038 |
| 1151768 | 1153724 | 1159709 | 1161379 | 1160089 | 1168907 | 1182069 | 1197626 |
| 1149426 | 1147919 | 1150666 | 1156744 | 1159642 | 1166888 | 1177803 | 1195324 |
| 1146459 | 1145188 | 1142432 | 1151222 | 1155331 | 1161359 | 1169528 | 1187339 |

TABLE VI

| | | | | | | | |
|---|---|---|---|---|---|---|---|
| −2.15% | −1.78% | −0.94% | −0.36% | −0.05% | 1.02% | 2.75% | 3.91% |
| −1.72% | −1.52% | −0.84% | −0.24% | 0.09% | 1.06% | 2.55% | 3.53% |
| −1.41% | −1.37% | −0.63% | 0.06% | 0.28% | 0.81% | 2.24% | 3.21% |
| −1.18% | −1.11% | −0.48% | 0.10% | 0.01% | 0.42% | 2.05% | 3.08% |
| −1.32% | −1.07% | −0.50% | −0.06% | −0.46% | 0.17% | 1.64% | 2.78% |
| −1.44% | −1.27% | −0.76% | −0.62% | −0.73% | 0.03% | 1.16% | 2.49% |
| −1.64% | −1.77% | −1.53% | −1.01% | −0.76% | −0.14% | 0.79% | 2.29% |
| −1.89% | −2.00% | −2.24% | −1.48% | −1.13% | −0.62% | 0.08% | 1.61% |

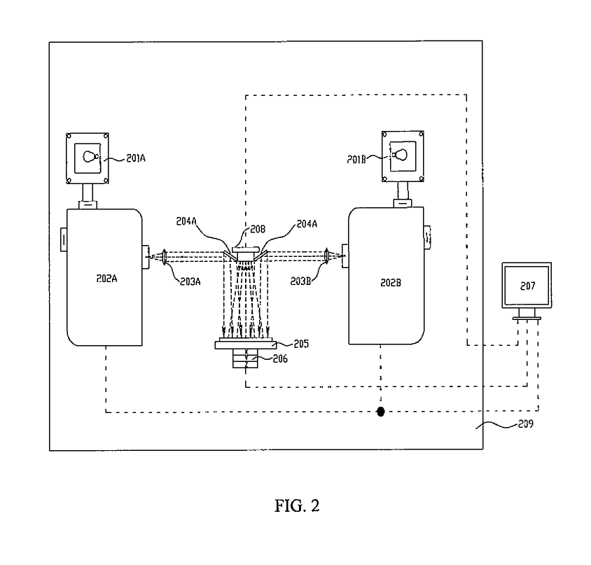

In another embodiment illustrated in FIG. 2, two lamps 201A and 201B, two monochromators 202A and 202B, two lens 203A and 203B, and two mirrors 204A and 204B are used to produce the uniform light source over the library element substrate 205, where the substances are detected and measured. The library element substrate is fixed or placed on the top of a translational stage 206, which is controlled by a computer 207. The stage enables a fast, area-focused analysis if the library element substrate area is too large. The diffuse reflectance spectral imaging and spectroscopy are obtained by the spatial resolved detector such as a CCD camera 208, which is also controlled by the computer 207. The imaging and data can be acquired, processed, and reduced by the computer 207 as well. All 201A, 201B, 202A, 202B, 203A, 203B, 204A, 204B, 205, 206, and 208 are placed in the enclosure of an imaging box 209.

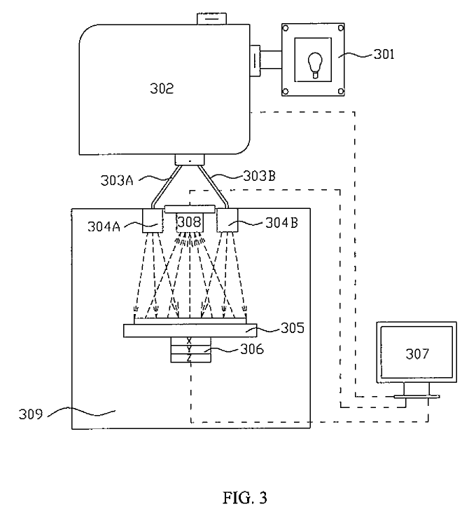

According to another aspect of the current invention, the substantially uniform monochromatic incident irradiation source in the apparatus has at least one irradiation source that generates uniform light source over the library element substrate. In one embodiment illustrated in FIG. 3, a lamp 301, a monochromator 302, two fiber-optic cables 303A and 303B, and two fiber-optic collimators 304A and 304B are used to produce the uniform light source over the library element substrate 305, where the substances are detected and measured. The library element substrate is fixed or placed on the top of a translational stage 306, which is controlled by a computer 307. The stage enables a fast, area-focused analysis if the library element substrate area is too large. The diffuse reflectance spectral imaging and spectroscopy are obtained by the spatial resolved detector such as a CCD camera 308, which is also controlled by the computer 307. The imaging and data can be acquired, processed, and reduced by the computer 307 as well. All 304A, 304B, 305, 306, and 308 are placed inside of an imaging box 309 except 301, 302, 303A and 303B are located outside of the imaging box 309.

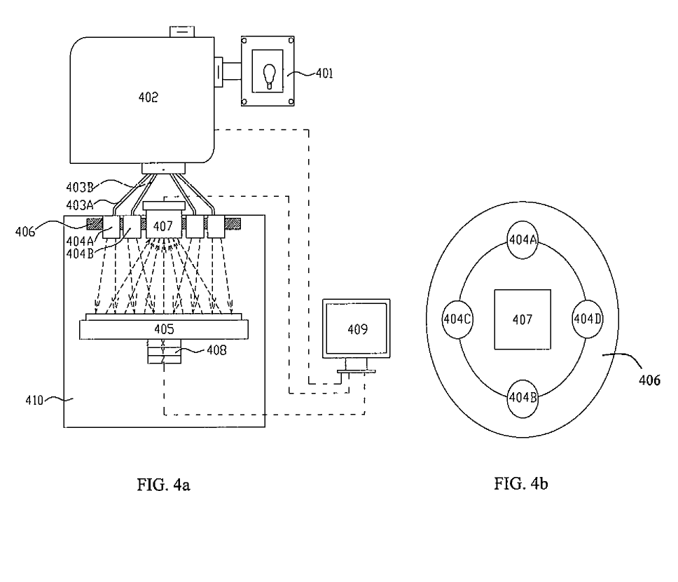

In another embodiment illustrated in FIG. 4a, a lamp 401, a monochromator 402, more than two fiber-optic cables 403A, 403B, and more, and more than two fiber-optic collimators 404A, 404B, and more are used to produce the uniform light source over the library element substrate 405, where the substances are detected and measured. More than two collimators are arranged uniformly around a spatial resolved detector by a collimator chassis 406. The spatial resolved detector such as a CCD camera 407 is used to obtain the diffuse reflectance spectral imaging and spectroscopy. The library element substrate is fixed or placed on the top of a translational stage 408, which is controlled by a computer 409. The stage enables a fast, area-focused analysis if the library element substrate area is too large, which is also controlled by the computer 409. The imaging and data can be acquired, processed, and reduced by the computer 409 as well. All fiber-optic collimators (404A, 404B, and more), 405, 406, 407, and 408 are placed inside of an imaging box 410 except 401, 402, partial length of fiber-optic cables is located outside of the imaging box 410. FIG. 4b is an overlook view of the fiber-optic collimator chassis 406, which holds the fiber-optic collimators 404A, 404B, 404C, and 404D to generate the uniform light source over the library element substrate. The CCD camera 407 is in the middle and surrounded by many collimators.

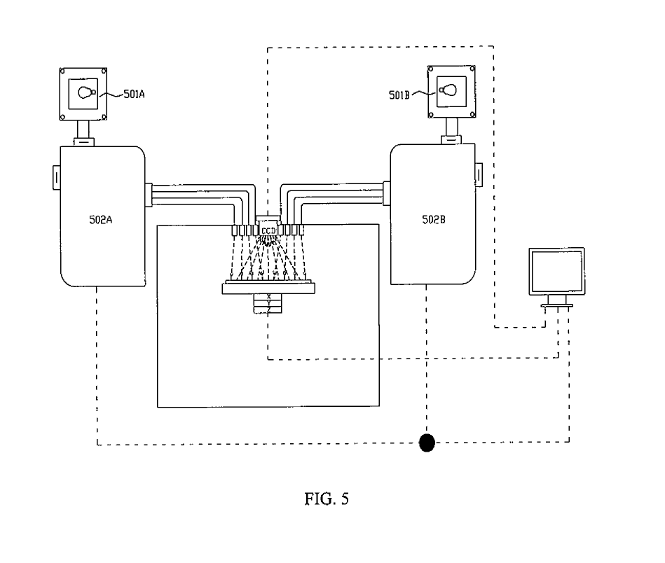

Further, in another embodiment illustrated in FIG. 5, two lamps 501A and 501B, two monochromators 502A and 502B, more fiber-optic cables, and more fiber-optic collimators can be used to generate the uniform monochromatic incident irradiation source. Without going further, the current invention has no limitation to above-mentioned embodiments.

According to another aspect of the current invention, in one embodiment as illustrated at FIG. 1, FIG. 2, FIG. 3, FIG. 4, and FIG. 5, the lamps 101, 201A, 201B, 301, 401, 501A, and 501B, are either any type of the UV, UV-visible, and infrared lamps or any combination type of the UV, UV-visible, and infrared lamps that depends on their commercial availability and measured substance inquiries. Further, the monochromators 102, 202A, 202B, 302, 402, 502A, and 502B, their corresponding optic components, and the spatial resolved detector such as the CCD camera 10, 208, 308, and 407 must also be sensitive corresponding to their lamp's wavelength. More preferable, the infrared lamps are either near infrared or mid-infrared lamps.

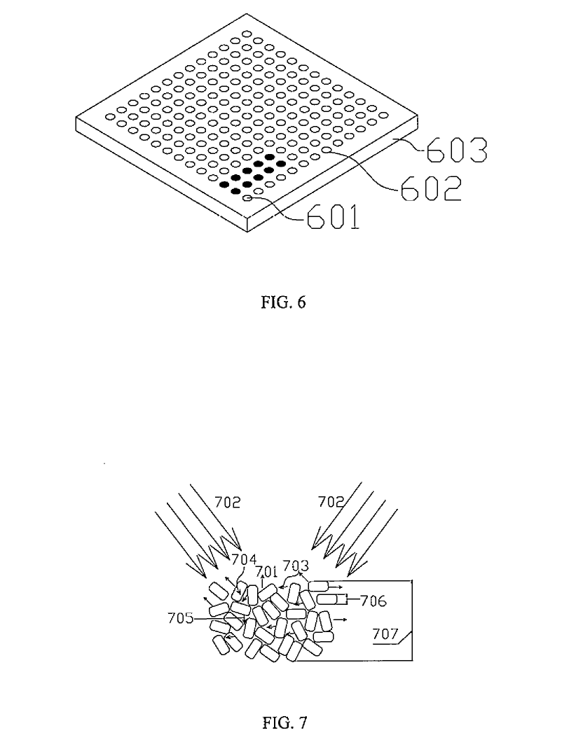

According to another aspect of current invention, the library element substrate is a carrier for measured substances to diffusely reflect the monochromatic incident irradiation source. In one embodiment, the measured substances are in the solid-phase such as powders, fine particles, rough sheets, rough chips, tablets, and more. In another embodiment illustrated in FIG. 6, when the substance is in powders 601, the substances are put into the array wells 602 on the library element substrate 603. The library element substrate has many array wells, and the well shape can be either circle, or triangle, or square, or any other geometric shapes in M rows and N columns, wherein M and N are integers. The materials for library element substrate are either plastics, or rubbers, or ceramics, or metals. In another embodiment, the measured substances are in the format of sheets or chips, and the measured substances are placed on the library element substrate directly. The library element substrate has no array wells in this embodiment. The materials for library element substrate are either plastics, or rubbers, or ceramics, or metals. In another embodiment, the measured substances are in the liquid-phase, and the diffuse reflectance solid media particles, which do not absorb the irradiation sources or have little absorption in the measured wavelength range, need to be added into the array wells for facilitating the diffuse reflectance spectral imaging and spectroscopy. The diffuse reflectance solid media particles are either silica, or other commercially available diffuse reflectance solid media such as SPECTRALON®. In another embodiment, a plurality of two or more materials in any type of formats are added or transferred to promote certain chemical reactions in the array wells on the library element substrate, and the reactions can be either wet chemical reaction or dry chemical reaction. The materials for reactions can be transferred either manually, or mechanically, or through a conduit system. The produced products can be measured accordingly.

According to another aspect of current invention, in one embodiment, the library element substrate is providing a plurality of measured substances in the array wells on the substrate, and the measured substances are physically transferred on the library element substrate from other sources in solid-phase, and/or liquid-phase through a conduit system, and/or manually transferring process, and/or a handheld device such as a pipette or a spatula, and/or an automated pipetting robot device, and/or other material deposition techniques. In another embodiment, the library element substrate is providing a plurality of measured substances in the array wells on the substrate, and the library element substrate is physically moved to the translational stage from other high-throughput library system or facility. In another embodiment, the library element substrate has diffuse reflectance solid media particles added that do not absorb the irradiation sources or have little absorbance when a plurality of product substances are in liquid-phase, and the diffuse reflectance solid media particles are to facilitate the diffuse reflectance process.

According to another aspect of current invention, in one embodiment, the translational stage is adjustable in x, y, and z axis, which is controlled by the computer in order to optimize “the best” position and to obtain the uniformity of incident irradiation over the library element substrate. In another embodiment, the translational stage is controllable in x axis, y axis, and θ angle in order to optimize “the best” position and to obtain the uniformity of incident irradiation over the library element substrate.

According to another aspect of current invention, in one embodiment, the spatial resolved detector is a UV-visible light, and/or infrared light sensitive CCD camera. In another embodiment, the spatial resolved detector is a UV-visible light, and/or infrared light sensitive photodiode array detector, and the like.

According to another aspect of current invention, in one embodiment, the imaging box is a black box that can hold the incident irradiation source such as lamps and monochromators, avoid any potential harm to the environment and operator, and hold optical components such as lens, mirrors, the diffuse reflectance library element substrate, and the spatial resolved detector. In another embodiment, the imaging box is an enclosure that can hold fiber-optic collimators, the diffuse reflectance library element substrate, and the spatial resolved detector.

According to another aspect of current invention, in one embodiment, the computer as both controller and data acquisition system controls monochromatic incident irradiation source, the translational stage, and the spatial resolved detector, and records the integrated intensity of the diffuse reflectance over the measured substances on the library elements substrate.

According to another aspect of current invention, in one embodiment, the computer as the data reduction system comprises plotting full characteristic diffuse reflectance spectrum as a function of scanned wavelength or wavenumber range for measured substances. In another embodiment, the computer as the data reduction system comprises plotting calibration curve for measured substances, calculating unknown concentration, and reporting error analysis.

### Diffuse Reflectance Spectroscopy

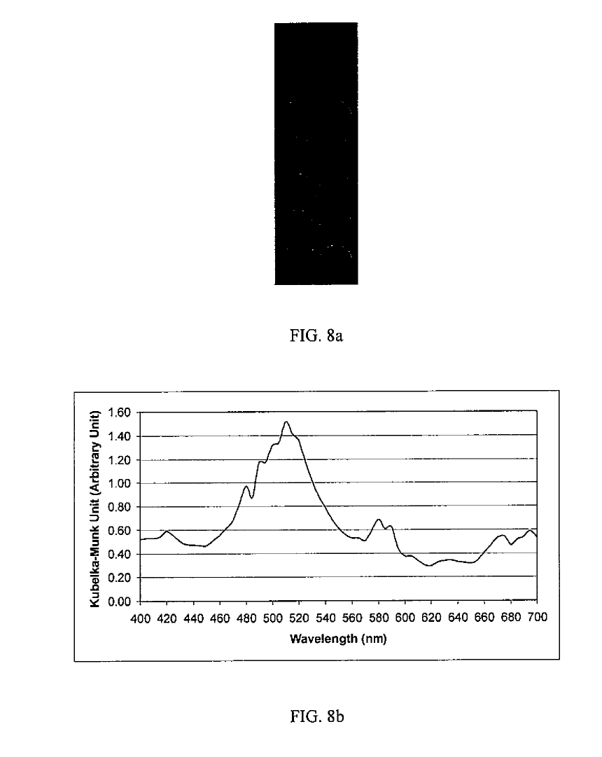

Diffuse Reflectance Spectroscopy (DRS) is a technique that collects and analyzes scattered light energy. This technique is widely used for measurement of fine particles and powders, as well as rough surface. As illustrated in FIG. 7, the intensity of diffusely reflected light 701 is independent of angle of incident irradiation 702, and it is an isotropic phenomenon. The diffuse reflectance happens after multiple reflection 703, refraction 704, and diffraction 705 inside the measurement substance. Due to the limiting assumption that the particle size 706 making up the layer must be much smaller than the total thickness 707, this diffuse reflectance technique is reasonably good for UV-visible, near infrared, and mid-infrared light sources. Sampling for DRS is fast and easy because little or no sample preparation for solid substances is required.

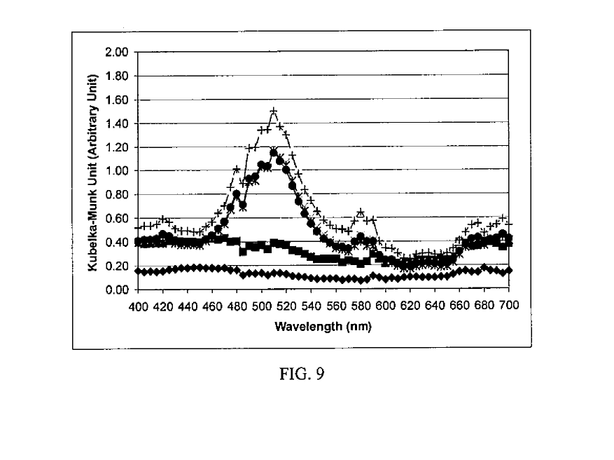

When the monochromatic incident irradiation beam enters the substance, it can either be reflected off the surface of a particle or be transmitted through a particle. The irradiation beam reflecting off the surface is sometime lost. The irradiation beam that passes through a particle can either reflect off the next particle or be transmitted through the next particle. This transmission-reflectance event can occur many times in the substance, which depends on the type of substance, substance particle sizes, and the layer thickness of the substance. Finally, reflected light can be collected by using the spatial resolved detector such as a CCD camera for spectral imaging and spectroscopy purpose, and the diffuse reflectance spectral imaging and spectroscopy (DFSIS) of substance are obtained as illustrated in FIG. 8a (FIG. 5a is a typical spectral imaging of measured substances) and FIG. 8b. (FIG. 8b is a typical spectroscopy of measured substances in visible spectrum region) Because the incident irradiation light is partially absorbed by the measured substance, it provides the substance property information for qualitative and quantitative analysis.

### Full Characteristic Diffuse Reflectance Spectrum of Measured Substances

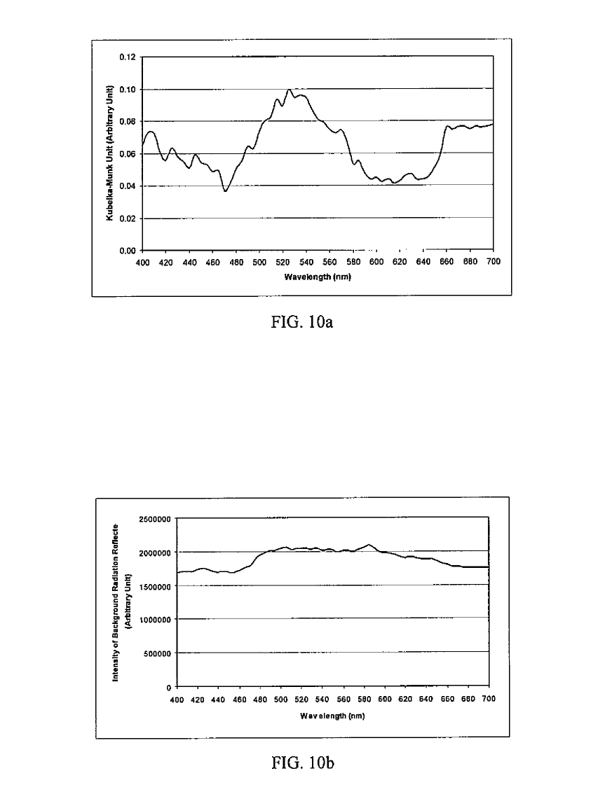

According to another aspect of the current invention, in one embodiment, when the measured substances are in the solid-phase such as wet chemistry synthesized V₂O₅/MgF₂ photo-catalysts in different V₂O₅ concentration, and the synthesized MgF₂ matrix is used as a background measurement. A full visible characteristic diffuse reflectance spectrum for measured substances located in the array wells over the library element substrate is obtained as illustrated in FIG. 9. In another embodiment, the synthesized V₂O/MgF₂ photo-catalysts are grinded and sieved in certain sizes range.

According to another aspect of the current invention, in one embodiment, the full UV-visible, near infrared, and mid-infrared characteristic diffuse reflectance spectrum for measured substances can be achieved at any apparatus set up illustrated at FIG. 1, 2, 3, 4, or 5.

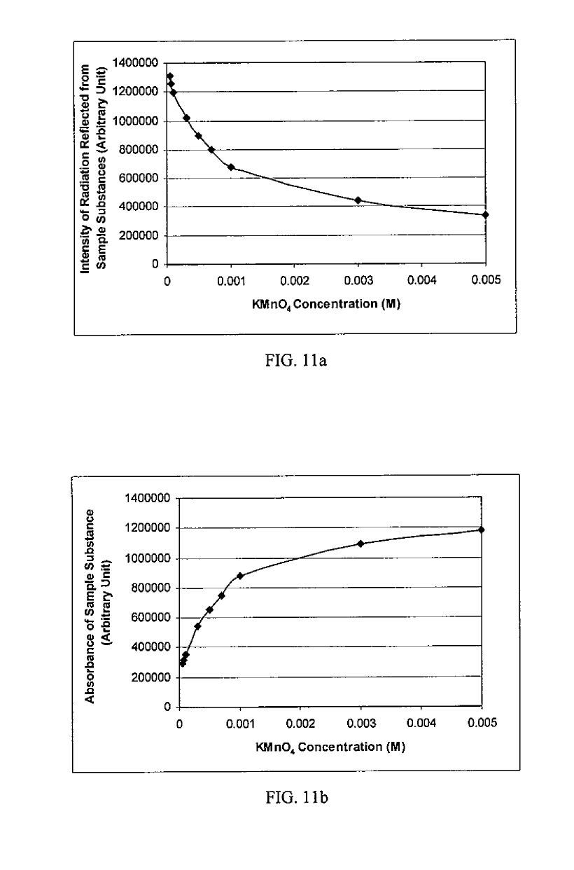

According to another aspect of the current invention, in one embodiment, when the measured substances are in the liquid-phase such as KMnO₄ liquid solution, and the diffuse reflectance solid media particle, which is silica, is added into array wells for facilitating the diffuse reflectance spectral imaging and spectroscopy. The diffuse reflectance of silica is used as a background measurement. A full visible characteristic diffuse reflectance spectrum for KMnO₄ located in the array wells on the library element substrate is obtained as illustrated in FIG. 10a. FIG. 10b is the diffuse reflectance spectrum of silica. In another embodiment, the measured substances such as KMnO₄ solution are physically transferred in the array wells on the library element substrate through a pipette. In another embodiment, the measured substances such as KMnO₄ solution are physically transferred in the array wells on the library element substrate through a plurality of conduit system, and/or an automated pipetting robot device.

According to another aspect of the current invention, generally, the methods for a full diffuse reflectance spectrum for measured substances is accomplished as follows:

A. the radiation from the monochromatic irradiation sources penetrates the surface layer of the substance particles, in which the substances are background substances and measured substances in the array wells on the library element substrate;

B. the library element substrate is located on the translational stage, which is controlled by computer. The translational stage can be adjusted in x, y, and z axis in order to optimize “the best” position and to obtain the uniformity of incident irradiation over the library element substrate;

C. the spatial resolved detector such as a CCD camera or photodiode array mounted on the top of the imaging box captures the light reflection over library element substrate at a specific wavelength scan range and a scan rate, which is controlled by the data acquisition system in the computer; and

D. the data reduction system processes all data acquired and reports in a plot form such as reflectance as the function of wavelength or wavenumber.

### The Kubelka-Munk Theory of Reflectance

The Kubelka-Munk theory of reflectance works well when the following conditions are met:

a. the incident light diffuses;

b. the diffuse light is an isotropic distribution;

c. the diffuse particles is randomly distributed over the substrate;

d. the diffuse particle sizes are much smaller than thickness of layer.

The theory works best for optically thick materials where >50% of light is reflected and <20% is transmitted. The Kubelka-Munk unit, K/S, can be simplified as K/S=(1−Rᵢⱼ)²/2Rᵢⱼ. Rᵢⱼ is defined as the reflectance (Iᵢⱼ/Iᵢⱼ⁰), is the intensity ratio of radiation reflected from the measured substances (Iᵢⱼ) to the reflectance from a background (Iᵢⱼ⁰) for a specific array well located at i row and j column on the library element substrate, in which the array wells on the library element substrate are an array in M rows and N columns. Here, K is the Absorption Coefficient, which is the limiting fraction of absorption of light energy per unit thickness, as thickness becomes very small. S is the Scattering Coefficient, which is the limiting fraction of light energy scattered backwards per unit thickness as thickness tends to zero.

According to another aspect of the current invention, generally, the methods for a series of full diffuse reflectance spectrum plot for measured substances can be accomplished as follows:
a. Iᵢⱼ, which is the intensity of radiation reflected from the measured substances for a specific array well located at i row and column on the library element substrate, as the function of wavelength or wavenumber scanned at a specific spectrum range;
b. Aᵢⱼ, which is the absorbance of the measured substances for a specific array well located at i row and j column on the library element substrate and is the difference (Iᵢⱼ⁰−Iᵢⱼ) of Iᵢⱼ and Iᵢⱼ⁰, as the function of wavelength or wavenumber scanned at a specific spectrum range;
c. Rᵢⱼ, which is the intensity ratio (Iᵢⱼ/Iᵢⱼ⁰) of radiation reflected from the measured substances (Iᵢⱼ) to the reflectance from a background (Iᵢⱼ⁰) for a specific array well located at i row and j column on the library element substrate, as the function of wavelength or wavenumber scanned at a specific spectrum range;
d. Log 1/Rᵢⱼ, or Ln 1/Rᵢⱼ, as the function of wavelength or wavenumber scanned at a specific spectrum range; and
e. Kubelka-Munk unit, K/S versus wavelength or wavenumber scanned at a specific spectrum range. Here, the Kubelka-Munk unit is expressed as (1−Rᵢⱼ)²/2Rᵢⱼ.

### Quantitative Analysis for Measured Substances

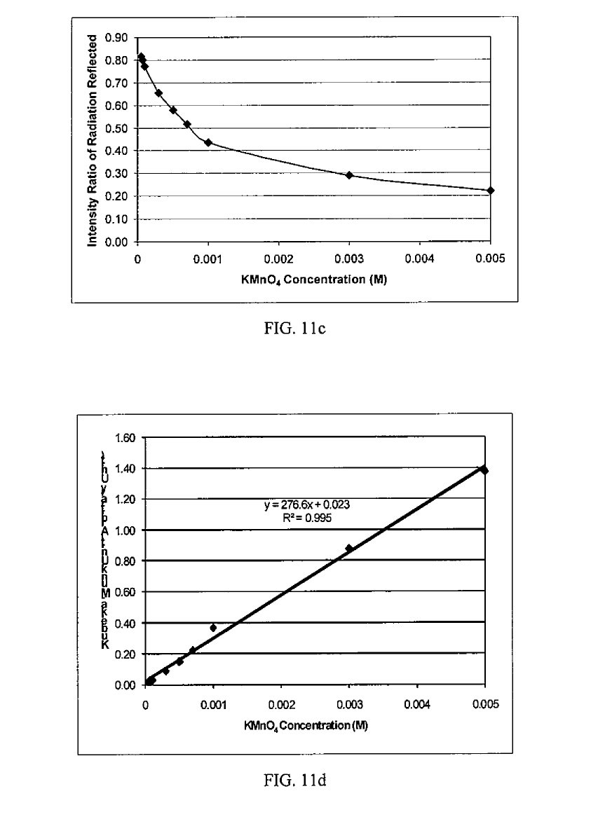

According to another aspect of the current invention, in one embodiment, when the measured substances are in the liquid-phase such as KMnO₄ solution, and the diffuse reflectance solid media particle, which is silica, is added into array wells for facilitating the diffuse reflectance spectral imaging and spectroscopy. The diffuse reflectance of silica is used as a background measurement. A visible characteristic diffuse reflectance in Iᵢⱼ, Aᵢⱼ, Rᵢⱼ, Log 1/Rᵢⱼ, Ln 1/Rᵢⱼ, Kubelka-Munk unit at the wavelength of 540 nm for KMnO₄ solutions between 5×10⁻⁵ M to 5×10⁻³ M is recorded and the data is processed. The calibration curves can be Iᵢⱼ, Aᵢⱼ, Rᵢⱼ, Log 1/Rᵢⱼ, Ln 1/Rᵢⱼ, and Kubelka-Munk unit as the function of KMnO₄ concentration. FIG. 11a is the calibration curve of the intensity of radiation reflected from the measured substances as the function of KMnO₄ concentration.

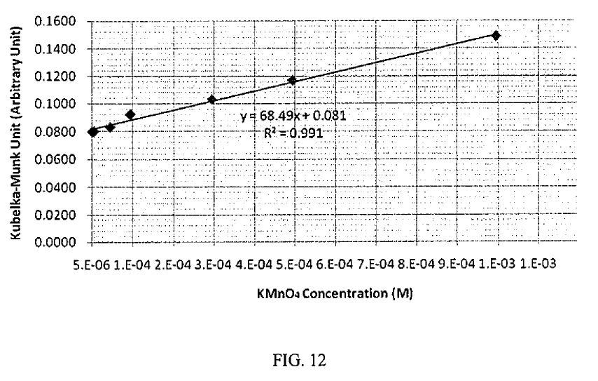

FIG. 11b is the calibration curve of the absorbance of measured substances as the function of KMnO₄ concentration. FIG. 11c is the calibration curve of the intensity ratio of radiation reflected from the measured substances as the function of KMnO₄ concentration. FIG. 11d is the calibration curve of Kubelka-Munk unit versus KMnO₄ concentrations. This calibration shows a good linear relationship between Kubelka-Munk unit versus KMnO₄ concentrations. The calibration curves are very useful for the quantitative analysis for unknown measured substances. In another embodiment, the measured substances such as KMnO₄ solutions are physically transferred in the array wells on the library element substrate through a pipette. In another embodiment, the measured substances such as KMnO₄ solutions are physically transferred in the array wells on the library element substrate through a plurality of conduit system, and/or an automated pipetting robot device. Further, in another embodiment, the calibration curves are also obtained for the measured substances in solid-phase. In another embodiment, when the lens is used for generating uniform irradiation source, the linear range for calibration curve between Kubelka-Munk unit versus concentrations is expanded from 5×10⁻⁶ M to 1×10⁻³ M as illustrated in FIG. 12.

According to another aspect of the current invention, generally, the methods for the diffuse reflectance of measured substances to plot a series of calibration curves are accomplished as follows:

A. the radiation from the monochromatic irradiation sources penetrates the surface layer of the substance particles, in which the substances are background substances and measured substances in the array wells on the library element substrate;

B. the library element substrate is located on the translational stage, which is controlled by computer. The translational stage can be adjusted in x, y, and z axis in order to optimize “the best” position and to obtain the uniformity of incident irradiation over the library element substrate;

C. the spatial resolved detector such as a CCD camera or photodiode array mounted on the top of the imaging box captures the light reflection over library element substrate at a characteristic wavelength or wavenumber, which is controlled by the data acquisition system in the computer; and

D. the data reduction software processes all data acquired and reports in a calibration curve, thus the unknown concentration for measured substances can be reported and error analysis can also be conducted.

According to another aspect of the current invention, generally, the methods for a series of diffuse reflectance calibration curve for measured substances can be accomplished as follows:
a. Iᵢⱼ, which is the intensity of radiation reflected from the measured substances for a specific array well located at i row and j column on the library element substrate, as the function of concentration at the characteristic wavelength or wavenumber of measured substances;
b. Aᵢⱼ, which is the absorbance of the measured substances for a specific array well located at i row and j column on the library element substrate and is the difference (Iᵢⱼ⁰−Iᵢⱼ) of Iᵢⱼ and Iᵢⱼ⁰, as the function of concentration at the characteristic wavelength or wavenumber of measured substances;
c. Rᵢⱼ, which is the intensity ratio (Iᵢⱼ/Iᵢⱼ⁰) of radiation reflected from the measured substances (Iᵢⱼ) to the reflectance from a background (Iᵢⱼ⁰) for a specific array well located at i row and j column on the library element substrate, as the function of concentration at the characteristic wavelength or wavenumber of measured substances;
d. Log 1/Rᵢⱼ, or Ln 1/Rᵢⱼ, as the function of concentration at the characteristic wavelength or wavenumber of measured substances; and
e. Kubelka-Munk unit, K/S, versus measure substance concentrations at the characteristic wavelength or wavenumber. Here, the Kubelka-Munk unit is expressed as (1−Rᵢⱼ)²/2Rᵢⱼ.

We claim:

1. a high-throughput spectroscopy apparatus, comprising:
a. at least one substantially monochromatic incident irradiation source;
b. a library element substrate including a plurality of wells defining a plurality of cavities;
c. one or more optical components arranged to direct the irradiation source onto the library element substrate;
d. a translational stage operably engaged with the library element substrate; and
e. a spatially resolved detector responsive to the irradiation source.

2. The apparatus of claim 1, wherein a wavelength filtering element is not present in the path of the radiation in the region between the library element and the spatially resolved detector.

3. The apparatus of claim 1, wherein the irradiation source comprises a plurality of irradiation sources providing substantially uniform illumination of the library element substrate.

4. The apparatus of claim 1, further including an imaging box that houses the incident irradiation source.

5. The apparatus of claim 1, further including a data acquisition system and a data reduction system.

6. The apparatus of claim 1, wherein the monochromatic radiation provided by the monochromatic irradiation source is selected from the group consisting of UV, UV-visible, and infrared radiation.

7. The apparatus of claim 6, wherein the irradiation source provides radiation having a wavelength between about 200 nm and about 800 nm.

8. The apparatus of claim 6, wherein irradiation source provides radiation having a wavelength between about 800 nm and about 40,000 nm.

9. The apparatus of claim 1, wherein the monochromatic incident irradiation source includes one or more lamps, one or more monochromators, one or more lenses, and one or more mirrors.

10. The apparatus of claim 1 further comprising:
a. an imaging box;
b. a data acquisition system; and
c. a data reduction system.

11. The apparatus of claim 10, wherein the irradiation source is remotely positioned with respect to the imaging box, and the components arranged to direct the irradiation source onto the library element substrate comprise fiber-optic cables and fiber-optic collimators.

12. The apparatus of claim 9, wherein the monochromatic incident irradiation source includes one or more lamps, one or more monochromators, two or more fiber-optic cables, and two or more fiber-optic collimators.

13. The apparatus of claim 1, the library element substrate is a diffuse reflectance library element wherein one or more of the plurality of wells includes a substance that diffusely reflects the irradiation source.

14. The apparatus of claim 12, wherein the substance is a solid-phase substance selected from the group consisting of powders and fine particles.

15. The apparatus of claim 12, wherein the substance is mixture of liquid-phase substances and diffusely reflecting solid media particles.

16. The apparatus of claim 15, wherein the diffusely reflecting solid media particles do not substantially absorb the radiation from the irradiation source.

17. The apparatus of claim 15, wherein the diffusely reflecting solid media particles are selected from silica and SPECTRALON® materials.

18. The apparatus of claim 1, wherein the plurality of wells is arranged on the library element in a circular, triangular, rectangular or square-shaped pattern.

19. The apparatus of claim 18, wherein the plurality of wells is suitable for performing a desired chemical reaction therein.

20. The apparatus of claim 19, wherein the chemical reaction is a wet chemical reaction or a dry chemical reaction.

21. The apparatus of claim 18, further including means for transferring reagents to one or more of the plurality of wells in the library element.

22. The apparatus of claim 21, wherein the means for transferring reagents comprises a mechanical system or a conduit system.

23. The apparatus of claim 1, wherein the library element substrate has no array wells.

24. The apparatus of claim 1, wherein the translational stage is moveable along at least one of an x-axis, a y-axis, a z-axis or an angle θ relative to the vertical axis of the apparatus, and further includes a computer-operated controller for moving the translational stage to a desired position.

25. The apparatus of claim 1, wherein the spatial resolved detector is selected from the group of UV-visible light detectors and infrared light sensitive CCD camera, infrared light sensitive photodiode array detector and combinations thereof.

26. A method of conducting high-throughput diffuse reflectance spectral imaging and spectroscopy, comprising:
a. providing a source of substantially uniform monochromatic radiation;
b. providing a library element substrate including a plurality of wells defining a plurality of cavities, the cavities having one or more substances therein, the substances including therein one or more diffusely reflecting solid media particles, wherein the diffusely reflecting solid media particles do not substantially absorb radiation provided by the sources;
c. moving the library element substrate to the translational stage;
d. directing the radiation onto the library element substrate; and
e. detecting one or more signals associated with a reflected portion of the radiation via a spatially resolved detector.

27. The method of claim 26, wherein the method does not include filtering the reflected portion of the radiation at one or more points between the library element substrate and the spatially resolved detector.

28. The method of claim 26, wherein the substances are in the liquid or solid-phase.

29. The method of claim 28, wherein solid-phase substances are metal or nonmetal oxides, metal or nonmetal halides, metal or nonmetal oxyhalides, or mixtures thereof.

30. The method of claim 28, further including mixing diffusely reflecting solid media particles with the liquid phase or solid phase substances.

31. The method of claim 26, further including transferring the substance to the plurality of wells with a manual process or an automated pipetting system or a plurality of conduits.

32. The method of claim 26, wherein
a. the spatially resolved detector is a CCD camera or photodiode array mounted on the top of an imaging box and captures a portion of the radiation reflected from the library element substrate; and
b. the data acquired by the detector is processed by a data processing program configured to report information including reflectance, wavelength, or wavenumber in a graphical format.

33. The method of claim 26, wherein a full diffuse reflectance spectrum for substances is a series of full diffuse reflectance spectrum plots, comprising:
a. Iᵢⱼ, wherein Iᵢⱼ is the intensity of radiation reflected from the substances for a desired well of the library element substrate, as the function of wavelength or wavenumber scanned at a specific spectrum range;
b. Aᵢⱼ, wherein Aᵢⱼ is the absorbance for the desired well of the library element substrate and is the difference of Iᵢⱼ and Iᵢⱼ⁰ (Iᵢⱼ⁰−Iᵢⱼ), as the function of wavelength or wavenumber scanned at a specific spectrum range;
c. Rᵢⱼ, wherein Rᵢⱼ is the intensity ratio of radiation reflected from the measured substances (Iᵢⱼ) to the reflectance from a background (Iᵢⱼ⁰) for a specific array well located at i row and j column on the library element substrate, as the function of wavelength or wavenumber scanned at a specific spectrum range;
d. Log 1/Rᵢⱼ, or Ln 1/Rᵢⱼ, as the function of wavelength or wavenumber scanned at a specific spectrum range; and
e. Kubelka-Munk unit, K/S versus wavelength or wavenumber scanned at a specific spectrum range. Here, the Kubelka-Munk unit is expressed as (1−Rᵢⱼ)²/2Rᵢⱼ.

34. The method of claim 26, further including determining one or more calibration curves.

35. The method of claim 34, wherein the diffuse reflectance of measured substances to plot a series of calibration curves, comprising:
a. Iᵢⱼ, wherein Iᵢⱼ is the intensity of radiation reflected from the measured substances for a specific array well located at i row and j column on the library element substrate, as the function of concentration at the characteristic wavelength or wavenumber of measured substances;
b. Aᵢⱼ, wherein Aᵢⱼ is the absorbance for a specific array well located at i row and j column on the library element substrate and is the difference of Iᵢⱼ and Iᵢⱼ⁰ (/Iᵢⱼ⁰−Iᵢⱼ), as the function of concentration at the characteristic wavelength or wavenumber of measured substances;
c. Rᵢⱼ, wherein Rᵢⱼ is the intensity ratio of radiation reflected from the measured substances (Iᵢⱼ) to the reflectance from a background (Iᵢⱼ⁰) for a specific array well located at i row and j column on the library element substrate, as the function of concentration at the characteristic wavelength or wavenumber of measured substances;
d. Log 1/Rᵢⱼ, or Ln 1/Rᵢⱼ, as the function of concentration at the characteristic wavelength or wavenumber of measured substances; and
e. Kubelka-Munk unit, K/S, versus measure substance concentrations at the characteristic wavelength or wavenumber. Here, the Kubelka-Munk unit is expressed as (1−Rᵢⱼ)²/2Rᵢⱼ.
